(19) United States
(12) Patent Application Publication
(10) Pub. No.: US 2012/0107696 A1
(43) Pub. Date: May 3, 2012

(54) SECONDARY BATTERY

(75) Inventors: Masaharu Sato, Nagaokakyo-shi (JP); Satoshi Shigematsu, Nagaokakyo-shi (JP); Koichi Watanabe, Nagaokakyo-shi (JP); Yozo Miura, Nagaokakyo-shi (JP); Takuya Koizumi, Nagaokakyo-shi (JP)

(73) Assignee: MURATA MANUFACTURING CO., LTD., Nagaokakyo-shi (JP)

(21) Appl. No.: 13/337,881

(22) Filed: Dec. 27, 2011

Related U.S. Application Data
(63) Continuation of application No. PCT/JP2010/070474, filed on Nov. 17, 2010.

(30) Foreign Application Priority Data
Dec. 14, 2009 (JP) 2009-282846

(51) Int. Cl. H01M 4/60; H01M 10/056; H01M 10/02

(52) U.S. Cl. 429/326; 429/188; 429/199; 429/345; 429/346; 429/344; 429/337; 429/336; 429/339

(57) ABSTRACT

An electrode active material mainly includes an organic compound having, in a structural unit thereof, a conjugated diamine structure represented by the general formula (I), and an electrolyte includes a carbonate ester compound represented by the general formula (II). In the formulae, R₁ to R₄ represent substituted or unsubstituted alkyl groups, or the like, whereas X₁ to X₄ represent a hydrogen atom or a substituent.

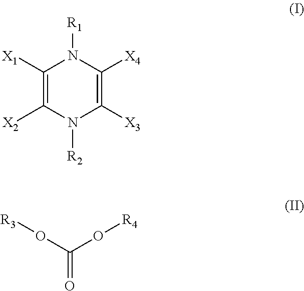

A secondary battery is achieved which has a high energy density and thus produces a high output, and has favorable cycle characteristics with a small capacity degradation even in the case of repeating charge and discharge.

This is a continuation-in-part of application Serial Number PCT/JP2010/070474, filed Nov. 17, 2010, the entire contents of which is incorporated herein by reference.

### TECHNICAL FIELD

The present invention relates to a secondary battery, and more particularly, relates to a secondary battery containing an electrode active material and an electrolyte, which involves charge and discharge upon use of a battery electrode reaction.

### BACKGROUND ART

With the market growth of portable electronic devices such as cellular phones, laptop computers, and digital cameras, long-life secondary batteries which are high in energy density have been long overdue as cordless power sources for the electronic devices.

In response to this demand, secondary batteries have been developed which use an alkali metal ion such as a lithium ion as a charge carrier and utilize an electrochemical reaction involving the donation and acceptance of electric charges. In particular, lithium ion secondary batteries which are high in energy density have come into wide use now.

Among components of a secondary battery, an electrode active material refers to a material which directly contributes to a battery electrode reaction such as a charge reaction and a discharge reaction, and has a central role in the secondary battery. The battery electrode reaction refers to a reaction developed with the donation and acceptance of electrons by applying a voltage to the electrode active material electrically connected to an electrode placed in an electrolyte, which proceeds when the battery is charged or discharged. Therefore, the electrode active material has a central role in the secondary battery in terms of system as described above.

The lithium ion secondary batteries use a lithium-containing transition metal oxide as a positive electrode active material, and a carbon material as a negative electrode active material, and utilize insertion of and elimination reactions of lithium ions to and from these electrode active materials to carry out charging and discharging.

However, the lithium ion secondary batteries have a problem of a limited rate of charging and discharging because of the rate-limiting lithium ion transfer at the positive electrode. More specifically, the lithium ion transfer rate in the lithium ion secondary batteries is slow using a transition metal oxide as the positive electrode as compared with the electrolyte and the negative electrode, and for this reason, the rate-limiting battery reaction rate at the positive electrode limits the charge and discharge rate, thereby resulting in limitations on an increase in output and a reduction in charging time.

In order to solve this problem, research and development have been carried out actively on electrode active materials with the use of organic radical compounds in recent years.

Organic radical compounds have reactive unpaired electrons localized on radical atoms, thus making it possible to increase the concentration of reaction sites, and to expect the achievement of a high-capacity secondary battery. In addition, the radicals react at a fast reaction rate, and it is thus considered possible to complete the charging time in a short amount of time by utilizing a redox reaction of stable radicals for charge and discharge.

Patent Document 1 discloses active materials for secondary batteries, which use a nitroxyl radical compound, an oxy radical compound, and a nitrogen radical compound with a radical on a nitrogen atom.

Patent Document 1 discloses an example of using a highly stable nitroxyl radical as a radical, and for example, confirms that charge and discharge can be carried out over 10 or more cycles in the case of repeating charge and discharge when a secondary battery is prepared with, for example, an electrode layer including a nitronylnitroxide compound as a positive electrode and lithium-attached copper foil as a negative electrode.

Patent Document 2 proposes an electrode containing a compound which has a diazine N,N′-dioxide structure as an electrode active material, and Patent Document 3 proposes an electrode active material containing an oligomer or polymer compound which has a diazine N,N′-dioxide structure in a side chain.

In Patent Documents 2 and 3, a polymer compound having a diazine N,N′-dioxide compound or diazine N,N′-dioxide structure in a side chain functions as an electrode active material, which is contained in the electrode as a starting reactant, a product, or an intermediate product, in a discharge reaction of an electrode reaction or a charge and discharge reaction thereof. Furthermore, it is considered that the donation and acceptance of electrons in the redox reaction can achieve five different states, and thereby also allows a multielectron reaction involving therein two or more electrons.

### PATENT DOCUMENTS

Patent Document 1: Japanese Patent Application Laid-Open No. 2004-207249 (paragraph numbers [0278] to [0282])
Patent Document 2: Japanese Patent Application Laid-Open No. 2003-115297 (claim 1, paragraph numbers [0038] and
Patent Document 3: Japanese Patent Application Laid-Open No. 2003-242980 (claim 1, paragraph numbers [0044] and

### DISCLOSURE OF THE INVENTION

### Problem to be Solved by the Invention

In Patent Document 1 where the organic radical compound such as a nitroxyl radical compound is used for the electrode active material, the charge and discharge reaction is limited to a reaction involving only one electron. More specifically, when a multielectron reaction involving two or more electrons is developed in the case of the organic radical compound, decomposition or the like of the radical occurs due to lack of radical stability, and the radical disappears, thereby losing the reversibility of the charge and discharge reaction. For this reason, the reaction has to be limited to a one-electron reaction in the case of the organic radical compound in Patent Document 1, and it is difficult to achieve a multielectron reaction from which a high capacity can be expected.

In the case of Patent Documents 2 and 3, while a multielectron reaction involving two or more electrons is also considered to be possible, the stability is not sufficient in the oxidation and reduction states, which results in bad cycle characteristics. Thus, when the charge and discharge cycle is repeated, the energy density becomes substantially decreased in a short period of time, and for this reason, Patent Documents 2 and 3 have failed to be put into practical use.

As described above, it is difficult for conventional secondary batteries as in Patent Documents 1 to 3 to achieve a balance between the capacity increased by a multielectron reaction and the stability to the charge and discharge cycle, even when the organic radical compound or the compound having a diazine structure is used for the electrode active material. More specifically, no secondary battery has been achieved yet which has a sufficiently high energy density and thus produces a high output, and favorable cycle characteristics, and has a long life.

The present invention has been achieved in view of these circumstances, and an object of the present invention is to provide a secondary battery using an organic compound for an electrode active material, which stabilizes the electrode active material, has a high energy density and thus produces a high output, and has favorable cycle characteristics with a small capacity degradation even in the case of repeated charge and discharge.

### Means for solving the problem

The inventors have carried out earnest research in order to achieve the object, thereby finding that an organic compound having, in a structural unit thereof, a conjugated diamine structure is excellent in terms of stability in the oxidation and reduction states, with a carbonate ester compound contained in an electrolyte. Therefore, the use of the organic compound as an electrode active material makes it possible to achieve a secondary battery which is capable of a multielectron reaction involving two or more electrons in a redox reaction. Moreover, the organic compound makes it possible to charge the battery with a large quantity of electricity even in the case of the organic compound having a low molecular weight, thus achieve a secondary battery including an electrode active material with a high capacity density.

The present invention has been achieved on the basis of this finding, and a secondary battery according to the present invention contains an electrode active material and an electrolyte, and repeats charge and discharge through a battery electrode reaction of the electrode active material, and the secondary battery is characterized in that the electrode active material mainly includes an organic compound having a conjugated diamine structure in a structural unit thereof, and the electrolyte includes a carbonate ester compound.

In addition, the organic compound in the secondary battery according to the present invention is preferably represented by the following general formula:

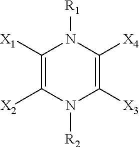

In the formula, R₁ and R₂ represent any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amine group, a substituted or unsubstituted amide group, a substituted or unsubstituted sulfone group, a substituted or unsubstituted thiosulfonyl group, a substituted or unsubstituted sulfoneamide group, a substituted or unsubstituted imine group, a substituted or unsubstituted azo group, and linking groups comprising a combination of one or more of these groups. X₁ to X₄ represent at least one of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted arylene group, a substituted or unsubstituted aromatic heterocycle group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group, a substituted or unsubstituted acyloxy group, and the substituents include cases in which the substituents together form a ring structure.

Furthermore, the carbonate ester compound in the secondary battery according to the present invention is preferably represented by the following general formula:

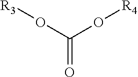

In the formula, R₃ and R₄ represent any of a substituted or unsubstituted alkyl group, a substituted or unsubstituted alkylene group, a substituted or unsubstituted cycloalkyl group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amine group, a substituted or unsubstituted amide group, a substituted or unsubstituted sulfone group, a substituted or unsubstituted thiosulfonyl group, a substituted or unsubstituted sulfoneamide group, a substituted or unsubstituted imine group, a substituted or unsubstituted azo group, and linking groups comprising a combination of one or more of these groups, and the substituents include cases in which the substituents together form a ring structure.

In addition, the electrode active material in the secondary battery according to the present invention is preferably any of a starting reactant, a product, and an intermediate product at least in a discharge reaction of the battery electrode reaction.

The secondary battery according to the present invention preferably includes a positive electrode and a negative electrode, and the positive electrode preferably mainly includes the electrode active material.

### Advantageous Effects of the Invention

In the secondary battery according to the present invention, the electrode active material mainly includes the organic compound having, in a structural unit thereof, a conjugated diamine structure, and the electrolyte contains the carbonate ester compound. The secondary battery is excellent in terms of stability during charge and discharge, that is, in an oxidation state and a reduction state, is capable of a multielectron reaction involving two or more electrons in a redox reaction, and can be charged with a large quantity of electricity even in the case of a low molecular weight, thereby making it possible to achieve a secondary battery including an electrode active material with a high capacity density.

The secondary battery can achieve a balance between the multielectron reaction and the stability to the charge and discharge cycle, thus making it possible to achieve a long-life secondary battery which has a high energy density and thus produces a high output, and has favorable cycle characteristics with a small capacity degradation even in the case of repeating charge and discharge.

Moreover, the secondary battery also has a reduced environmental burden in consideration of safety, because the electrode active material mainly includes the organic compound.

### BRIEF EXPLANATION OF DRAWINGS

FIG. 1 is a cross-sectional view illustrating an embodiment of a coin-type battery as a secondary battery according to the present invention.

### BEST MODE FOR CARRYING OUT THE INVENTION

Next, an embodiment of the present invention will be described in detail.

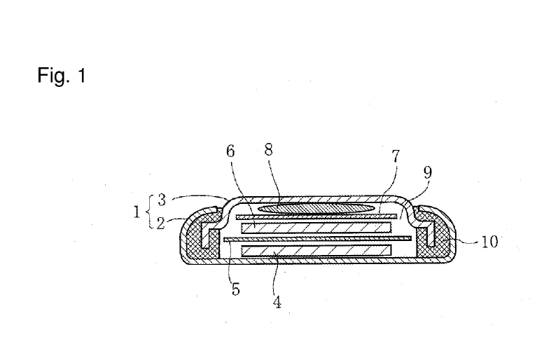

FIG. 1 is a cross-sectional view illustrating a coin-type secondary battery as an embodiment of a secondary battery according to the present invention.

A battery can 1 includes a positive electrode case 2 and a negative electrode case 3, and the positive electrode case 2 and the negative electrode case 3 are each formed in the shape of a disc-like thin plate. Furthermore, a positive electrode 4 obtained by forming a positive electrode active material (an electrode active material) in the shape of a sheet is placed in the central bottom of the positive electrode case 2 constituting a positive electrode current collector. In addition, a separator 5 formed from a porous film such as polypropylene is stacked on the positive electrode 4, and a negative electrode 6 is further stacked on the separator 5. For example, lithium metal foil laminated on Cu, and a lithium storage material such as graphite or hard carbon applied onto the metal foil can be used as the negative electrode 6. Moreover, a negative electrode current collector 7 formed from Cu or the like is stacked on the negative electrode 6, and a metallic spring 8 is placed on the negative electrode current collector 7. Furthermore, an electrolyte solution 9 is located into the internal space, and the negative electrode case 3 is firmly fixed to the positive electrode case 2 against the urging force of the metallic spring 8, and sealed with a gasket 10 interposed therebetween.

In the secondary battery described above, the positive electrode active material mainly includes an organic compound having, in a structural unit thereof, a conjugated diamine structure. In addition, the electrolyte solution 9 contains an electrolyte salt and an organic solvent for dissolving the electrolyte salt, and the organic solvent includes a carbonate ester compound. It is to be noted that carbonate ester compound is preferably contained at 5 volume % or more. Thus, the stability can be improved in an oxidation state and a reduction state during charge and discharge, and a secondary battery can be thus achieved which includes a positive electrode active material with a high capacity density.

The positive electrode active material is not to be considered particularly limited in terms of the type of the organic compound, as long as the organic compound has a conjugated diamine structure in a structural unit thereof, and can include, for example, an organic compound represented by the following general formula (1) in the structural unit.

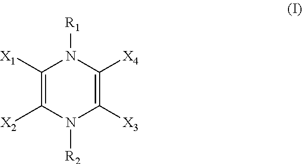

In formula I, R₁ and R₂ represent any of a substituted or unsubstituted alkyl group, a substituted or unsubstituted alkylene group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amine group, a substituted or unsubstituted amide group, a substituted or unsubstituted sulfone group, a substituted or unsubstituted thiosulfonyl group, a substituted or unsubstituted sulfoneamide group, a substituted or unsubstituted imine group, a substituted or unsubstituted azo group, and linking groups comprising a combination of one or more of these groups. X₁ to X₄ represent at least one of a hydrogen atom, a halogen atom, a hydroxyl group, a nitro group, a cyano group, a carboxyl group, a substituted or unsubstituted alkyl group, a substituted or unsubstituted alkenyl group, a substituted or unsubstituted cycloalkyl group, a substituted or unsubstituted arylene group, a substituted or unsubstituted aromatic heterocycle group, a substituted or unsubstituted aralkyl group, a substituted or unsubstituted amino group, a substituted or unsubstituted alkoxy group, a substituted or unsubstituted aryloxy group, a substituted or unsubstituted alkoxycarbonyl group, a substituted or unsubstituted aryloxycarbonyl group, a substituted or unsubstituted acyl group, a substituted or unsubstituted acyloxy group, and the substituents include cases in which the substituents together form a ring structure. These groups generally contain 1 to about 10 carbon atoms.

It is to be noted that the respective substituents listed above are not to be considered limited as long as the substituents fall into the respective categories. However, desired substituents are preferably selected such that the number average molecular weight of the electrode active material is 270 or less per electron of the battery electrode reaction, because the charge amount which can be accumulated per unit mass of the positive electrode active material is decreased as the molecular weight is increased.

Moreover, such organic compounds can include, for example, compounds represented by or including the following chemical formulae (2) to (7) in which n represents the number of repeating units containing the conjugated diamine structure.

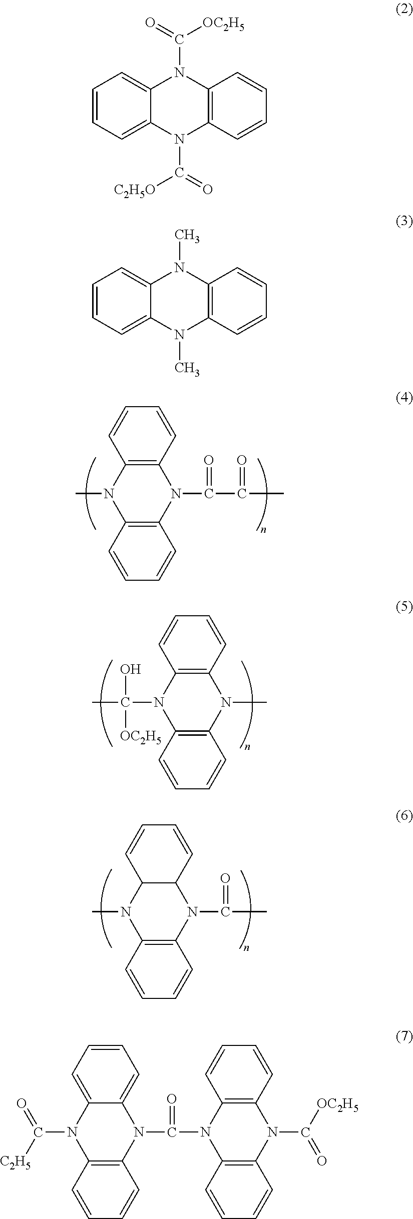

The carbonate ester compound contained in an organic solvent of the electrolyte solution 9 is also not to be considered particularly limited, and for example, the compound represented by the following general formula (8) can be used.

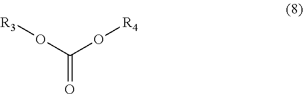

Here, R₃ and R₄ represent any of a substituted or unsubstituted alkyl group, a substituted or unsubstituted alkylene group, a substituted or unsubstituted cycloalkyl group, a substituted or unsubstituted arylene group, a substituted or unsubstituted carbonyl group, a substituted or unsubstituted acyl group, a substituted or unsubstituted alkoxycarbonyl group, a substituted or unsubstituted ester group, a substituted or unsubstituted ether group, a substituted or unsubstituted thioether group, a substituted or unsubstituted amine group, a substituted or unsubstituted amide group, a substituted or unsubstituted sulfone group, a substituted or unsubstituted thiosulfonyl group, a substituted or unsubstituted sulfoneamide group, a substituted or unsubstituted imine group, a substituted or unsubstituted azo group, and linking groups comprising a combination of one or more of these groups, and these substituents include cases in which the substituents together form a ring structure.

Moreover, such carbonate ester compounds can include, for example, dimethyl carbonate represented by the chemical formula (9), diethyl carbonate represented by the chemical formula (10), dipropyl carbonate represented by the chemical formula (11), diphenyl carbonate represented by the chemical formula (12), ethylene carbonate represented by the chemical formula (13), and propylene carbonate represented by the chemical formula (14).

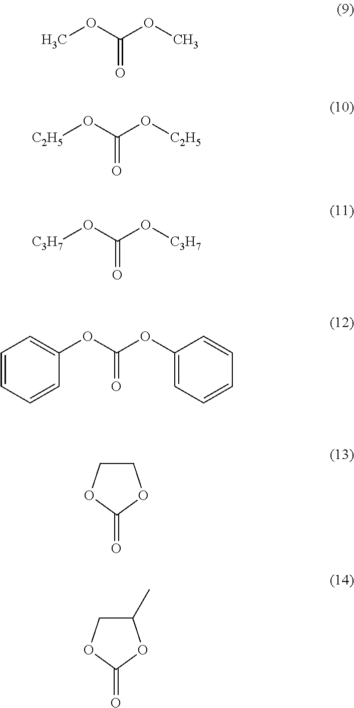

In the carbonate ester compound represented by the general formula (8), R₃ and R₄ are, in particular, preferably substituted or unsubstituted alkyl groups, and for example, the carbonate ester compounds of the chemical formulae (9) to (11) can be used preferentially.

The carbonate ester compound is contained in the electrolyte solution 9 as described above for the following reason.

The electrolyte solution 9 is prepared so as to have an ion conductivity of 10⁻⁵ to 10⁻¹ S/cm at room temperature, and interposed between the positive electrode 4 and the negative electrode 6 to transport charge carriers between the both electrodes. Thus, an electrolyte salt dissolved in an organic solvent in the present embodiment is used as this electrolyte solution 9.

If the electrolyte solution 9 contains no carbonate ester compound therein, the use of the organic compound having a conjugated diamine structure for the positive electrode active material will reduce the positive electrode active material to a material which is soluble in the electrolyte solution 9, and for this reason, the redox reaction is repeated between the positive electrode and the negative electrode, thereby possibly failing to effect the charge and discharge reaction.

For example, when an organic compound having a phenazine structure as the conjugated diamine structure is used for the positive electrode active material and LiPF₆ is used as the electrolyte salt, with no carbonate ester compound contained in the electrolyte solution 9, the organic compound including the phenazine structure will be reduced to phenazine which is soluble in the electrolyte solution 9, as expressed by the following chemical reaction formula (15). As a result, as expressed by the following chemical reaction formula (16), this phenazine will be repeatedly oxidized and reduced between the positive electrode 4 and the negative electrode 6, and for this reason, no redox reaction will be developed at the battery electrode, thereby possibly failing to effect the charge and discharge reactions.

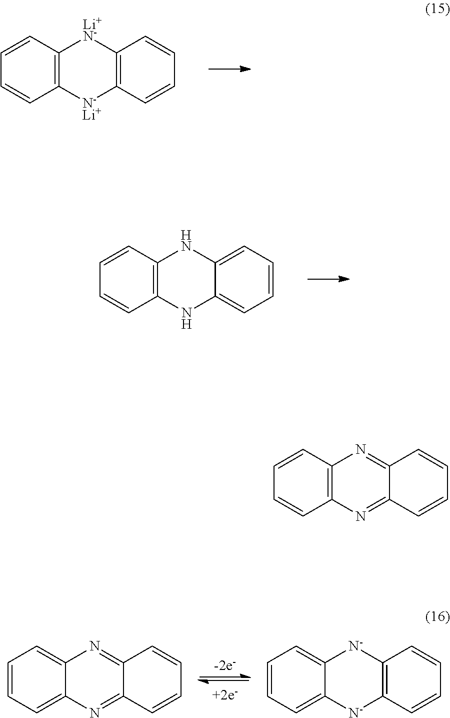

In contrast, for example, the a decomposition reaction through the reduction of the organic compound having a phenazine structure when the carbonate ester compound is contained in the electrolyte solution 9, proceeds with the carbonate ester compound reacting with the reduction product as expressed by the following chemical reaction formula (17) to decrease a product which forms during a side reaction of the charging and discharging, thereby functioning to convert the product to an active material for making charge and discharge possible. More specifically, when the organic compound having a phenazine structure is reduced and some molecule bonds are cut, the bonds are repaired in the presence of the carbonate ester compound in the electrolyte solution 9 to develop the charge and discharge reaction expressed by the chemical reaction formula (18).

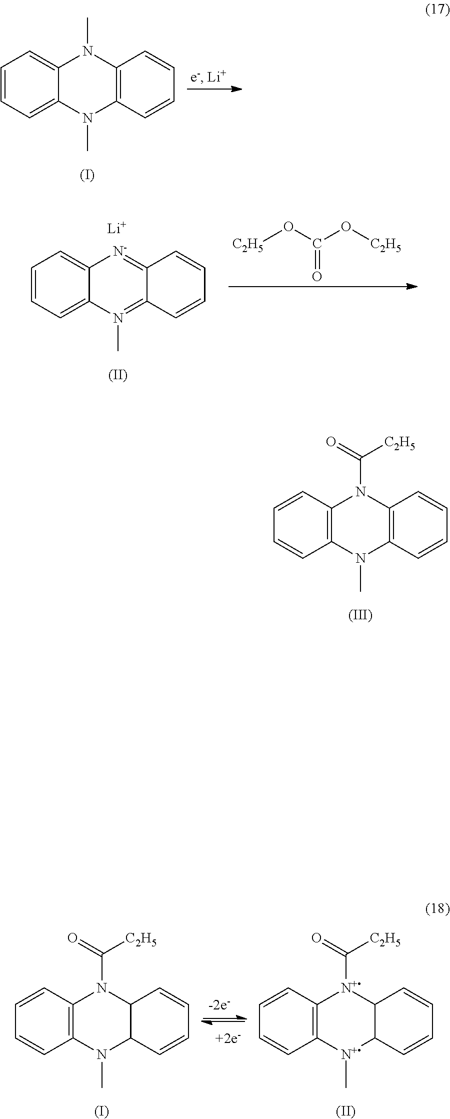

More specifically, two electrons per molecule of the organic compound (I) having the phenazine structure are involved in the reaction to produce a cation (II) when the carbonate ester compound is contained in the electrolyte, thereby allowing the capacity density to be increased as compared with the case of a one-electron reaction.

In the secondary battery described above, the positive electrode active material mainly includes the organic compound having, in a structural unit thereof, a conjugated diamine structure, such as a phenazine structure, and the electrolyte solution 9 contains the carbonate ester compound. Thus, the secondary battery is excellent in terms of stability during charge and discharge, that is, in an oxidation state and a reduction state, is capable of a multielectron reaction involving two or more electrons in a redox reaction, and can be charged with a large quantity of electricity even in the case of a low molecular weight, thereby making it possible to achieve a secondary battery including a positive electrode active material with a high capacity density.

In addition, the electrolyte solution 9 according to the present invention may contain more than one carbonate ester compounds. Therefore, for example, a mixed solution may be used which contains two or more of the carbonate ester compounds represented by the chemical formulae (9) to (14), or a mixed solution of a carbonate ester compound and a non-carbonate ester compound may be used. It is to be noted that γ-butyrolactone, tetrahydrofuran, dioxolane, sulfolane, dimethylformamide, dimethylacetoamide, N-methyl-2-pyrrolidone, etc. can be used as the non-carbonate ester compound.

As the electrolyte salt, LiClO₄, LiBF₄, LiCF₃SO₃, Li (CF₃SO₂)₂N, Li (C₂F₅SO₂)₂N, Li (CF₃SO₂)₃C, Li (C₂F₅SO₂)₃C, etc. can be used in addition to LiPF₆.

The molecular weight of the organic compound constituting the positive electrode active material is not particularly limited. However, if the moiety other than the diamine structure is increased in size, the molecular weight is increased, and the electric storage capacity per unit mass, that is, the capacity density is decreased. Therefore, the moiety other than the diamine structure preferably has a lower molecular weight.

In addition, as represented by the chemical formulae (4) to (6), polymers or copolymers of organic compounds having, in structural units thereof, a conjugated diamine structure can be also used, and even in that case, the molecular weight or molecular weight distribution is not particularly limited.

Next, an example of a method for manufacturing the secondary battery described above will be described in detail.

First, a positive electrode active material is formed in the shape of an electrode. For example, the positive electrode active material is mixed with a conductive aid and a binder, to which a solvent is added to provide slurry, and the slurry is applied by any coating method onto a positive electrode current collector, and dried to form a positive electrode.

The conductive aid is not to be considered particularly limited, and for example, carbonaceous particulate such as graphite, carbon black, and acetylene black; carbon fibers such as vapor-grown carbon fiber (VGCF), carbon nanotubes, and carbon nanohorn; conductive polymers such as polyaniline, polypyrrole, polythiophene, polyacetylene, and polyacene; etc. can be used therefor. In addition, two or more conductive aids can also be mixed and used. It is to be noted that the content of the conductive aid in the positive electrode 4 is preferably 10 to 80 weight %.

The binder is also not to be considered particularly limited, and various resins can be used therefor, such as polyethylene, polyvinylidene fluoride, polyhexafluoropropylene, polytetrafluoroethylene, a polyethylene oxide, and carboxymethyl cellulose.

Furthermore, the solvent is also not to be considered particularly limited, and basic solvents such as dimethylsulfoxide, dimethylformamide, N-methylpyrrolidone, propylene carbonate, diethyl carbonate, dimethyl carbonate, and γ-butyrolactone; nonaqueous solvents such as acetonitrile, tetrahydrofuran, nitrobenzene, and acetone; and protic solvents such as methanol and ethanol; etc. can be used.

In addition, the type of the solvent, the mixing ratio between the organic compound and the solvent, the type and amount of an additive, etc. can be arbitrarily set in consideration of demanded characteristics, productivity, etc. of the secondary battery.

Then, the positive electrode 4 is impregnated with the electrolyte solution 9 to infiltrate the positive electrode 4 with the electrolyte solution 9, and the positive electrode 4 is then placed on the positive electrode current collector in the central bottom of the positive electrode case 2. Then, the separator 5 impregnated with the electrolyte solution 9 is stacked on the positive electrode 4, the negative electrode 6 and the negative electrode current collector 7 are further stacked sequentially, and the electrolyte solution 9 is then introduced (e.g., injected) into the internal space. The metallic spring 8 is placed on the negative electrode current collector 9, the gasket 10 is arranged on the periphery, and the negative electrode case 3 is firmly attached to the positive electrode case 2 with the use of a swaging tool for external sealing, thereby preparing a coin-type secondary battery.

The positive electrode active material is reversibly oxidized or reduced by charge or discharge, and thus has a different structure and state in a charging condition, in a discharging state, or in a middle condition therebetween. However, the positive electrode active material in the present embodiment is included in any of a starting reactant (a material which develops during chemical reaction in the battery electrode reaction), a product (a material produced as a result of the chemical reaction), and an intermediate product at least in the discharge reaction. In addition, the discharge reaction has at least two discharge voltages, thereby making it possible to achieve a secondary battery including a positive electrode active material with a high capacity density at multiple voltages.

As described above, the secondary battery according to the present embodiment is configured with the use of the positive electrode active material which is excellent in terms of stability in the charge and discharge cycles, and has two or more multiple electrons involved in the reaction, thus making it possible to achieve a long-life secondary battery which has a high energy density and thus produces a high output, and has favorable cycle characteristics with a small capacity degradation even in the case of repeating charge and discharge.

Moreover, the secondary battery also has a reduced environmental burden with consideration for safety, because the positive electrode active material mainly includes the organic compound.

It is to be noted that the present invention is not to be considered limited to the embodiment described above, and various changes can be made without departing from the spirit of the present invention. For example, the chemical formulae (2) to (7) and (9) to (14) listed above are also by way of example for the organic compound mainly included in the positive electrode active material and the carbonate ester compound, and the organic compound and the carbonate ester compound are not to be considered limited to these examples. More specifically, as long as the electrode active material mainly includes the organic compound having, in a structural unit thereof, a conjugated diamine structure, and the electrolyte contains the carbonate ester compound therein, the redox reaction expressed by the chemical reaction formula (18) is believed to proceed, thus allowing the achievement of a secondary battery which has a high energy density and is excellent in terms of stability.

While the organic compound having, in a structural unit thereof, a conjugated diamine structure is used for the positive electrode active material in the present embodiment, it is also useful to use the organic compound for a negative electrode active material.

In addition, while the coin-type secondary battery has been described in the present embodiment, it comes near to stating the obvious that the shape of the battery is not to be considered particularly limited, and the present invention can also be applied to cylindrical, square, and sheet-shaped secondary batteries. Furthermore, the external packaging method is also not particularly limited, and metal cases, molding resins, aluminum laminate films, etc. may be also used.

Next, examples of the present invention will be described specifically.

It is to be noted that the following examples are by way of example, and the present invention is not to be considered limited to the following examples.

### Example 1

### Organic Compound

Obtained was 5,10-dihydrodimethylphenadine represented by the following chemical formula (3) from KANTO CHEMICAL CO., INC.

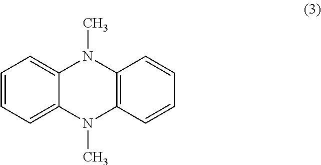

### Preparation of Secondary Battery

The 5,10-dihydrodimethylphenadine, 300 mg, a graphite powder, 600 mg, as a conductive aid, and a polytetrafluoroethylene resin, 100 mg, as a binder were combined and kneaded while mixing for providing overall homogeneity, thereby providing a mixture.

Then, this mixture was subjected to pressing to prepare a sheet-like member with a thickness of approximately 150 μm. Next, the sheet-like member was subjected to drying in vacuum at 80° C. for 1 hour, and punching into a circular shape with a diameter of 12 mm to prepare a positive electrode (positive electrode active material) mainly including 5,10-dihydrophenazine.

The positive electrode was placed on a positive electrode current collector, a separator of 20 μm in thickness, composed of a polypropylene porous film impregnated with the electrolyte solution described below, was further stacked on the positive electrode, and a negative electrode of lithium applied onto a negative electrode current collector composed of copper foil was further stacked on the separator, thereby forming a laminated body.

An electrolyte solution was prepared with LiPF₆ contained at a molar concentration of 1.0 mol/L in an ethylene carbonate/diethyl carbonate mixed solution as the carbonate ester compound. It is to be noted that the mixture ratio between ethylene carbonate and diethyl carbonate was adjusted to ethylene carbonate:diethyl carbonate=3:7 in terms of volume %.

Next, this electrolyte solution was delivered as 0.2 mL drops into the laminated body to impregnate the laminated body with the electrolyte solution.

Then, a metallic spring was placed on the negative electrode current collector, and with a gasket arranged on the periphery, the negative electrode case is joined to the positive electrode case for external sealing with the use of a swaging tool. Thus, a sealed coin-type secondary battery was prepared with the positive electrode active material composed of 5,10-dimethyldihydrophenazine, the negative electrode active material composed of metal lithium, and the electrolyte solution composed of LiPF₆ as the electrolyte salt and the ethylene carbonate/diethyl carbonate mixed solution as the organic solvent.

### Operation Check of Secondary Battery

The secondary battery prepared in the way described above was charged up to 4.0 V at a constant current of 0.1 mA, and then discharged down to 1.5 V at a constant current of 0.1 mA. The result confirmed that the secondary battery has a discharge capacity of 0.20 mAh with voltage plateaus at two charge and discharge voltages of 3.6 V and 3.0 V.

Then, the capacity density per electrode active material was calculated from this discharge capacity to obtain 160 Ah/kg.

The theoretical capacity density Q (Ah/kg) of the secondary battery is represented by the following formula (1).

$$Q = \frac{1000 \times ( Z \times 96500 )}{3600 \times W} \qquad ( 1 )$$

Z is the number of electrons involved in the battery electrode reaction, and W is the molecular weight of the electrode active material.

The molecular weight of 5,10-dihydrophenazine is 210.3, and thus, when the number Z of electrons involved in the battery electrode reaction is assumed to be 1, the theoretical capacity density Q will be 128 Ah/kg from the formula (1). Therefore, it has been confirmed that the 5,10-dihydrophenazine undergoes a multielectron reaction in which at least one electron is involved per repeating unit.

When charge and discharge were repeated in the range of 4.0 to 1.5 V, 80% or more of the initial capacity was able to be ensured even after 100 cycles. More specifically, a success was made in the achievement of an excellent secondary battery in terms of stability with a small capacity degradation even in the case of repeated charge and discharge.

After repeating 100 cycles of charge and discharge in the way described above, the secondary battery was taken apart to take out the positive electrode, soxhlet extraction was carried out with dichloromethane as a volatile solvent to spread out the extract with the use of an alumina thin layer. The presence of any substance corresponding to phenazine was not found.

Furthermore, the prepared secondary battery was charged up to 4.0 V at a constant current of 0.1 mA, then maintained with the voltage applied, and after 168 hours, discharged at a constant current of 0.1 mA. As a result, the discharge capacity was decreased as compared with the case of discharging immediately after charging, but able to be kept at 80% or more. More specifically, success was made in the achievement of an excellent secondary battery in terms of stability with a little self-discharge.

### Example 2

### Preparation of Secondary Battery

A secondary battery was prepared by the same method as in Example 1, except that a mixed solution of ethylene carbonate, diethyl carbonate, and propylene carbonate as the carbonate ester compound was used as the organic solvent for the electrolyte solution. It is to be noted that the mixture ratio among ethylene carbonate, diethyl carbonate, and propylene carbonate was adjusted to ethylene carbonate:diethyl carbonate:propylene carbonate=30:65:5 in terms of volume %.

### Operation Check of Secondary Battery

The secondary battery prepared as described above was subjected to an operation check by carrying out charge and discharge under the same conditions as in Example 1, to confirm that the secondary battery has a discharge capacity of 0.20 mAh with voltage plateaus at two charge and discharge voltages of 3.6 V and 3.0 V.

Thereafter, when charge and discharge were repeated in the range of 4.0 to 1.5 V, as in the case of Example 1, 80% or more of the initial capacity was able to be achieved even after 100 cycles. More specifically, success was made in the achievement of an excellent secondary battery in terms of stability with a small capacity degradation even in the case of repeating charge and discharge. In addition, when soxhlet extraction was carried out to spread out the extract with the use of an alumina thin layer by the same method as in Example 1, no substance corresponding to phenazine was found to be present.

Furthermore, the prepared secondary battery was likewise charged up to 4.0 V at a constant current of 0.1 mA, then maintained with the voltage applied, and after 168 hours, discharged at a constant current of 0.1 mA. As a result, the discharge capacity was decreased as compared with the case of discharging immediately after charging, but able to be kept at 80% or more. More specifically, success was made in the achievement of an excellent secondary battery in terms of stability with a little self-discharge.

### Example 3

### Preparation of Secondary Battery

A mixed solution of γ-butyrolactone represented by the following chemical formula (100) and diethyl carbonate as a carbonate ester was prepared as the organic solvent for the electrolyte solution. It is to be noted that the mixture ratio between γ-butyrolactone and diethyl carbonate was adjusted to γ-butyrolactone:diethyl carbonate=3:7 in terms of volume %.

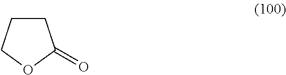

### Operation Check of Secondary Battery

The secondary battery prepared as described above was subjected to an operation check by carrying out charge and discharge under the same conditions as in Example 1, to confirm that the secondary battery has a discharge capacity of 0.20 mAh with voltage plateaus at two charge and discharge voltages of 3.6 V and 3.0 V.

Thereafter, when charge and discharge were repeated in the range of 4.0 to 1.5 V as in the case of Example 1, 80% or more of the initial capacity was able to be achieved even after 100 cycles. More specifically, success was made in the achievement of an excellent secondary battery in terms of stability with a small capacity degradation even in the case of repeating charge and discharge. In addition, when soxhlet extraction was carried out to spread out the extract with the use of an alumina thin layer by the same method as in Example 1, the presence of any substance corresponding to phenazine was not found.

Furthermore, the prepared secondary battery was likewise charged up to 4.0 V at a constant current of 0.1 mA, then maintained with the voltage applied, and after 168 hours, discharged at a constant current of 0.1 mA. As a result, the discharge capacity was decreased as compared with the case of discharging immediately after charging, but able to be kept at 80% or more. More specifically, success was made in the achievement of an excellent secondary battery in terms of stability with a little self-discharge.

### Example 4

### Preparation of Secondary Battery

A secondary battery was prepared by the same method as in Example 1, except that a mixed solution of 7-butyrolactone, as well as ethylene carbonate, diethyl carbonate, and propylene carbonate as carbonate esters was used as the organic solvent for the electrolyte solution. It is to be noted that the mixture ratio among γ-butyrolactone, ethylene carbonate, diethyl carbonate, and propylene carbonate was adjusted to γ-butyrolactone:ethylene carbonate:diethyl carbonate:propylene carbonate=0.22:0.22:0.52:0.04 in terms of volume %.

### Operation Check of Secondary Battery

The secondary battery prepared as described above was subjected to an operation check by carrying out charge and discharge under the same conditions as in Example 1, to confirm that the secondary battery has a discharge capacity of 0.20 mAh with voltage plateaus at two charge and discharge voltages of 3.6 V and 3.0 V.

Thereafter, when charge and discharge were repeated in the range of 4.0 to 1.5 V as in the case of Example 1, 80% or more of the initial capacity was able to be achieved even after 100 cycles. More specifically, success was made in the achievement of an excellent secondary battery in terms of stability with a small capacity degradation even in the case of repeating charge and discharge. In addition, when soxhlet extraction was carried out to spread out the extract with the use of an alumina thin layer by the same method as in Example 1, no substance corresponding to phenazine was found to be present.

Furthermore, the prepared secondary battery was likewise charged up to 4.0 V at a constant current of 0.1 mA, then kept with the voltage applied, and after 168 hours, discharged at a constant current of 0.1 mA. As a result, the discharge capacity was decreased as compared with the case of discharging immediately after charging, but able to be kept at 80% or more. More specifically, success was made in the achievement of an excellent secondary battery in terms of stability with a little self-discharge.

### Example 5

### Organic Compound

In accordance with the following synthesis scheme (A),
N,N′-bis(ethoxycarbonyl)-5,10-dihydrophenazine (Z) was synthesized.

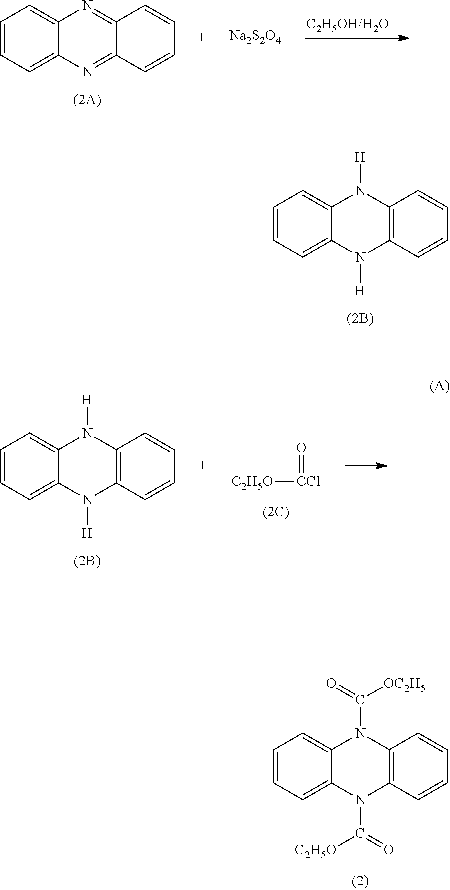

First, 28 mmol of phenazine (2A) was dissolved in 150 mL of ethanol, into which Na₂S₂O₄ dissolved in 150 mL of pure water was delivered by drops in an argon stream, and then subjected to stirring for 3 hours to precipitate 5,10-dihydrophenazine (2B).

Then, this precipitated 5,10-dihydrophenazine (2B) was filtered out, washed with pure water, and dried under reduced pressure.

Next, 7.7 mmol of the 5,10-dihydrophenazine (2B) and 25 mL of ethyl chloroformate (2C) were dried at 80° C. for 5 hours under an argon stream, the unreacted ethyl chloroformate (2C) was removed, and N,N′-bis(ethoxycarbonyl)-5,10-dihydrophenazine (2) as a red-brown solid was then obtained by recrystallization from methanol.

### Preparation of Secondary Battery

A secondary battery was prepared by the same method as in Example 1, except that the N,N′-bis(ethoxycarbonyl)-5,10-dihydrophenazine was used for the positive electrode active material.

### Operation Check of Secondary Battery

The secondary battery prepared as described above was subjected to an operation check by carrying out charge and discharge under the same conditions as in Example 1, to confirm that the secondary battery has a discharge capacity of 0.23 mAh with voltage plateaus at two charge and discharge voltages of 2.8 V and 2.5 V.

Then, the capacity density per electrode active material was calculated from this discharge capacity to obtain 160 Ah/kg.

The molecular weight of N,N′-bis(ethoxycarbonyl)-5,10-dihydrophenazine is 326.4, and thus, when the number Z of electrons involved in the battery electrode reaction is assumed to be 2, the theoretical capacity density will be 164 Ah/kg from the formula (1). Therefore, it has been confirmed that the N,N′-bis(ethoxycarbonyl)-5,10-dihydrophenazine undergoes a multielectron reaction in which at least two electrons are involved per repeating unit.

Thereafter, when charge and discharge were repeated in the range of 4.0 to 1.5 V as in the case of Example 1, 80% or more of the initial capacity was able to be realized even after 100 cycles. More specifically, success was made in the achievement of an excellent secondary battery in terms of stability with a small capacity degradation even in the case of repeating charge and discharge. In addition, when soxhlet extraction was carried out to spread out the extract with the use of an alumina thin layer by the same method as in Example 1, the presence of any substance corresponding to phenazine was not found.

In addition, the prepared secondary battery was likewise charged up to 4.0 V at a constant current of 0.1 mA, then maintained with the voltage applied for 168 hours, and then discharged at a constant current of 0.1 mA. As a result, the discharge capacity was decreased as compared with the case of discharging immediately after charging, but able to be kept at 80% or more. More specifically, success was made in the achievement of an excellent secondary battery in terms of stability with a little self-discharge.

### Example 6

### Synthesis of Organic Compound

As a starting raw material, 5,10-dihydrophenazine of the intermediate product in Example 4 was used to synthesize a polymer of a dihydrophenazine carbonyl compound in accordance with synthesis scheme (B).

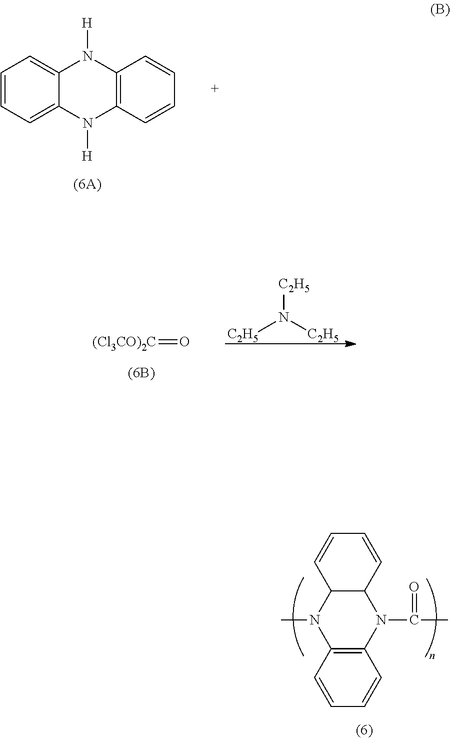

More specifically, first, 5,10-dihydrophenazine (6A) was prepared by the same method as in Example 4. Then, 30 mmol of 5,10-dihydrophenazine (6A) was dissolved in triethylamine ((C₂H₅)₃N), into which a gas produced from triphosgene (Cl₃CO)₂CO) was blown while stirring in a container equipped with a trap. When triphosgene is decomposed by the action of the triphosgene on triethylamine, three molecules of phosgene (6B) are produced. Then, the 5,10-dihydrophenazine (6A) and phosgene (6B) were stirred for 6 hours in a reaction container to react with each other, and the reactant was purified to obtain a polymer (6) of a dihydrophenazine carbonyl compound as a dark brown solid.

### Preparation of Secondary Battery

A secondary battery was prepared by the same method as in Example 1, except that the polymer of the dihydrophenazine carbonyl compound was used for the positive electrode active material.

### Operation Check of Secondary Battery

The secondary battery prepared in the way described above was charged and discharged under the same conditions as in Example 1, to confirm that the secondary battery has a discharge capacity of 0.22 mAh with voltage plateaus at two charge and discharge voltages of 2.7 V and 2.2 V.

Then, the capacity density per electrode active material was calculated from this discharge capacity to obtain 245 Ah/kg.

The molecular weight of the polymer of the dihydrophenazine carbonyl compound is 225.3 per repeating unit, and thus, when the number Z of electrons involved in the battery electrode reaction is assumed to be 2, the theoretical capacity density will be 238 Ah/kg from the formula (1). Therefore, it has been confirmed that the polymer of the dihydrophenazine carbonyl compound undergoes a multielectron reaction in which at least two electrons are involved per repeating unit.

When charge and discharge were repeated in the range of 4.0 to 1.5 V, 80% or more of the initial capacity was able to be produced even after 100 cycles. More specifically, success was made in the achievement of an excellent secondary battery in terms of stability with a small capacity degradation even in the case of repeating charge and discharge. In addition, when soxhlet extraction was carried out to spread out the extract with the use of an alumina thin layer by the same method as in Example 1, no substance corresponding to phenazine was identified.

In addition, the prepared secondary battery was likewise charged up to 4.0 V at a constant current of 0.1 mA, held with the voltage applied, and after 168 hours, discharged at a constant current of 0.1 mA. As a result, the discharge capacity was decreased as compared with the case of discharging immediately after charging, but able to be kept at 80% or more. More specifically, success was made in the achievement of an excellent secondary battery in terms of stability with a little self-discharge.

### Example 7

### Synthesis of Organic Compound

As a starting raw material, 5,10-dihydrophenazine of the intermediate product in Example 4 was used to synthesize a polymer of a dihydrophenazine dicarbonyl compound in accordance with a synthesis scheme (C).

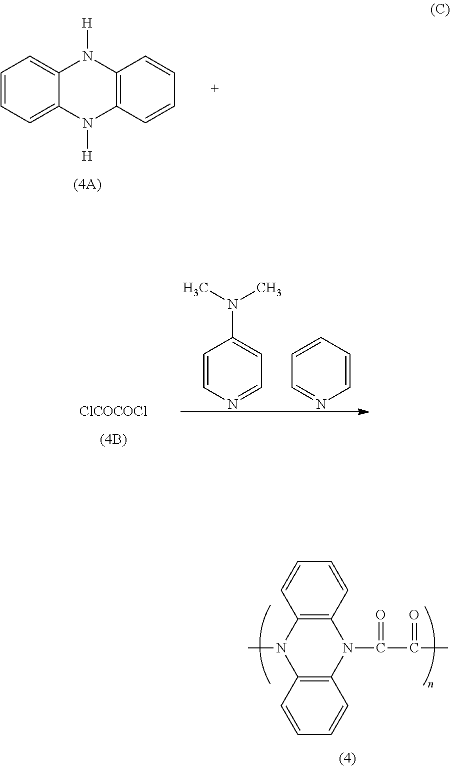

More specifically, 5,10-dihydrophenazine (4A) was first prepared by the same method as in Example 4. Then, 8.2 mmol of 5,10-dihydrophenazine (4A) and 20 mg of 4-dimethylaminopyridine were dissolved in 20 mL of dehydrated pyridine under an argon stream, to which a mixed solution of 5 mL of dehydrated tetrahydrofuran (C₄H₈O) and 8.2 mmol of oxalyl chloride (4B) was added at 0° C. The solution was stirred at room temperature for 1 hour, and thereafter, the temperature was increased to 60° C. to stir the solution for an additional 4 hours for reacting the solution. Then, the pyridine was removed, methanol was added, and a precipitated black powder was filtered to obtain a polymer (4) of a dihydrophenazine dicarbonyl compound.

### Preparation of Secondary Battery

A secondary battery was prepared by the same method as in Example 1, except that the polymer of the dihydrophenazine dicarbonyl compound was used for the positive electrode active material.

### Operation Check of Secondary Battery

The secondary battery prepared in the way described above was charged up to 4.0 V at a constant current of 0.1 mA, and then discharged down to 1.8 V at a constant current of 0.1 mA. The result has confirmed that the secondary battery has a discharge capacity of 0.20 mAh with voltage plateaus at two charge and discharge voltages of 2.8 V and 2.4 V.

The capacity density per electrode active material was calculated from this discharge capacity to obtain 240 Ah/kg.

The molecular weight of the polymer of the dihydrophenazine dicarbonyl compound is 236.2 per repeating unit, and thus, when the number Z of electrons involved in the battery electrode reaction is assumed to be 2, the theoretical capacity density will be 226.9 Ah/kg from the formula (1). Therefore, it has been confirmed that the polymer of the dihydrophenazine dicarbonyl compound undergoes a multielectron reaction in which at least two electrons are involved per repeating unit.

When charge and discharge were repeated in the range of 4.0 to 1.5 V, 80% or more of the initial capacity was able to be realized even after 100 cycles. More specifically, success was made in the achievement of an excellent secondary battery in terms of stability with a small capacity degradation even in the case of repeating charge and discharge. In addition, when soxhlet extraction was carried out to spread out the extract with the use of an alumina thin layer by the same method as in Example 1, the presence of any substance corresponding to phenazine was not found.

Furthermore, the prepared secondary battery was likewise charged up to 4.0 V at a constant current of 0.1 mA, kept with the voltage applied, and after 168 hours, discharged at a constant current of 0.1 mA. As a result, the discharge capacity was decreased as compared with the case of discharging immediately after charging, but was 80% or more. More specifically, success was made in the achievement of an excellent secondary battery in terms of stability with a little self-discharge.

### Comparative Example 1

### Preparation of Secondary Battery

A secondary battery was prepared by the same method as in Example 1, except that γ-butyrolactone (see Example 3) was used as the organic solvent for the electrolyte solution.

### Operation Check of Secondary Battery

The secondary battery prepared in the way described above was charged up to 4.0 V at a constant current of 0.1 mA, and then discharged down to 1.8 V at a constant current of 0.1 mA. The result has confirmed that the secondary battery has a discharge capacity of 0.20 mAh with voltage plateaus at two charge and discharge voltages of 2.8 V and 2.4 V.

However, when charge and discharge were repeated, the charge and discharge efficiency decreased gradually, and failed to charge the battery after 10 cycles. In addition, when soxhlet extraction was carried out to spread out the extract with the use of an alumina thin layer by the same method as in Example 1, a substance corresponding to phenazine was found to be present.

Thus, it is considered that phenazine dissolved in the electrolyte solution moves between the positive electrode and the negative electrode to repeat a redox reaction in Comparative Example 1, and it has been determined that the battery is not suitable as a secondary battery.

### INDUSTRIAL APPLICABILITY

A stable secondary battery is achieved which has a high energy density and thus produces a high output, and has favorable cycle characteristics with a small capacity degradation even in the case of repeating charge and discharge.

### DESCRIPTION OF REFERENCE SYMBOLS

4 positive electrode
6 negative electrode
9 electrolyte solution (electrolyte)

1. A secondary battery containing an electrode active material and an electrolyte, wherein the electrode active material comprises an organic compound having a conjugated diamine structural unit therein, and the electrolyte comprises a carbonate ester compound.

2. The secondary battery according to claim 1, wherein the organic compound is represented by the general formula 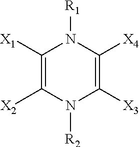
in which R₁ and R₂ individually represent a substituted or unsubstituted group selected from the group consisting of alkyl, alkylene, arylene, carbonyl, acyl, alkoxycarbonyl, ester, ether, thioether, amine, amide, sulfone, thiosulfonyl, sulfoneamide, imine, azo, and a linking group comprising a combination of one or more of these groups, and X₁ to X₄ individually represent at least one member of the group consisting of hydrogen, halogen, hydroxyl, nitro, cyano, carboxyl, substituted or unsubstituted alkyl, substituted or unsubstituted alkenyl, substituted or unsubstituted cycloalkyl, substituted or unsubstituted arylene, substituted or unsubstituted aromatic heterocycle, substituted or unsubstituted aralkyl, substituted or unsubstituted amino, substituted or unsubstituted alkoxy, substituted or unsubstituted aryloxy, substituted or unsubstituted alkoxycarbonyl, substituted or unsubstituted aryloxycarbonyl, substituted or unsubstituted acyl, substituted or unsubstituted acyloxy, and a ring formed by a combination of these substituents.

3. The secondary battery according to claim 2, wherein the carbonate ester compound is represented by the general formula 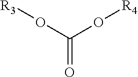
in which R₃ and R₄ individually represent a substituted or unsubstituted member selected from the group consisting of alkyl, alkylene, cycloalkyl, arylene, carbonyl, acyl, alkoxycarbonyl, ester, ether, thioether, amine, amide, sulfone, thiosulfonyl, sulfoneamide, imine, azo, and a straight chain or ring group comprising a combination of two or more of these groups.

4. The secondary battery according to claim 3, wherein the electrode active material structural unit has a molecular weight of 270 or less per electrode of the battery electrode reaction.

5. The secondary battery according to claim 4, comprising a positive electrode and a negative electrode, wherein the positive electrode comprises the electrode active material.

6. The secondary battery according to claim 5, wherein the R₃ and R₄ groups in the carbonate are individually a substituted or unsubstituted alkyl group.

7. The secondary battery according to claim 6, in which the organic compound is a phenazine.

8. The secondary battery according to claim 7, in which the electrolyte comprises at least one member of the group consisting of γ-butyrolactone, tetrahydrofuran, dioxolane, sulfolane, dimethylformamide, dimethylacetoamide, N-methyl-2-pyrrolidone.

9. The secondary battery according to claim 7, in which the electrolyte comprises at least one member of the group consisting of LiPF₆, LiClO₄, LiBF₄, LiCF₃SO₃, Li(CF₃SO₂)₂N, Li(C₂F₅SO₂)₂N, Li(CF₃SO₂)₃C, and Li(C₂F₅SO₂)₃C.

10. The secondary battery according to claim 9 in which the organic compound comprises at least one member of the group consisting of 5,10-dihydrodimethylphenadine, N,N′-bis(ethoxycarbonyl)-5,10-dihydrophenazine, a polymer containing 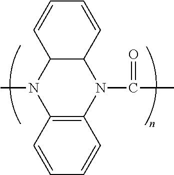
and a polymer containing 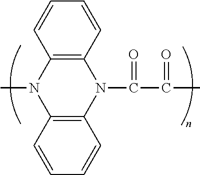
and in which the carbonate is at least one member of the group consisting of ethylene carbonate, diethyl carbonate and propylene carbonate.

11. The secondary battery according to claim 10, wherein the electrolyte has a room temperature ion conductivity of 10⁻⁵ to 10⁻¹ S/cm.

12. The secondary battery according to claim 1, wherein the carbonate ester compound is represented by the general formula 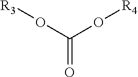
in which R₃ and R₄ individually represent a substituted or unsubstituted member selected from the group consisting of alkyl, alkylene, cycloalkyl, arylene, carbonyl, acyl, alkoxycarbonyl, ester, ether, thioether, amine, amide, sulfone, thiosulfonyl, sulfoneamide, imine, azo, and a straight chain or ring group comprising a combination of two or more of these groups.

13. The secondary battery according to claim 12, in which R₃ and R₄ individually represent a substituted or unsubstituted member selected from the group consisting of alkyl.

14. The secondary battery according to claim 1, comprising a positive electrode and a negative electrode, wherein the positive electrode comprises the electrode active material.

15. The secondary battery according to claim 1, wherein the carbonate ester compound is at least 5 vol % of the electrolyte.

16. The secondary battery according to claim 1, wherein the organic compound has a conjugated diamine structural unit having a molecular weight of 270 or less per electrode of the battery electrode reaction and which is at least one member of the group consisting of 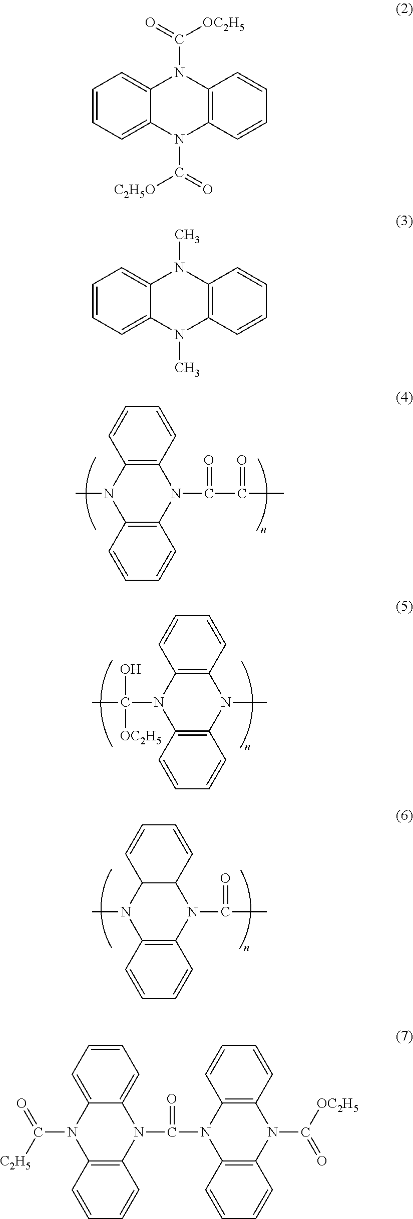
in which n is at least 1.

17. The secondary battery according to claim 1, wherein the electrolyte has a room temperature ion conductivity of 10⁻⁵ to 10⁻¹ S/cm.

18. The secondary battery according to claim 1, wherein the carbonate ester compound is at least one member of the group consisting of dimethyl carbonate, diethyl carbonate, dipropyl carbonate, diphenyl carbonate, ethylene carbonate, and propylene carbonate.

19. The secondary battery according to claim 1, wherein the solvent comprises at least one member of the group consisting of LiPF₆, LiClO₄, LiBF₄, LiCF₃SO₃, Li(CF₃SO₂)₂N, Li(C₂F₅SO₂)₂N, Li(CF₃SO₂)₃C, and Li(C₂F₅SO₂)₃C.

20. The secondary battery according to claim 19 wherein the solvent further comprises at least one member of the group consisting of γ-butyrolactone, tetrahydrofuran, dioxolane, sulfolane, dimethylformamide, dimethylacetoamide, and N-methyl-2-pyrrolidone.

21. The secondary battery according to claim 1, in which the organic compound is a phenazine.
